(19) United States
(12) Patent Application Publication
(10) Pub. No.: US 2026/0210375 A1
(43) Pub. Date: Jul. 23, 2026

(54) ROTOR, IN PARTICULAR FOR A TURBOMACHINE, METHOD FOR PRODUCING A ROTOR, AND TURBOMACHINE

(71) Applicant: Schubeler GmbH, Bad Lippspringe (DE)

(72) Inventors: Daniel Schübeler, Delbrück (DE); Jesse Schnebel, Detmold (DE)

(21) Appl. No.: 19/139,146

(22) PCT Filed: Nov. 8, 2023
(86) PCT No.: PCT/EP2023/081213

§ 371 Date: Jun. 13, 2025

(30) Foreign Application Priority Data
Dec. 14, 2022 (EP) 22213338.1

(51) Int. Cl. F04D 29/38; F04D 19/00

(52) U.S. Cl. CPC F04D 29/388; F04D 19/002; F05D 2300/6034

(57) ABSTRACT

The invention relates to a rotor, in particular for a turbomachine, comprising a rotor hub (20) and a plurality of rotor blades (21) attached to the rotor hub (20). A plurality of reinforcing fibres (32) extends from a first rotor blade (21) through the interior of the rotor hub (20) to a second rotor blade (21). A first filler body (35) is arranged inside the rotor hub (20), which has a guide surface (36) with which a guide for the reinforcing fibres (32) acting in the axial direction of the rotor is provided. The first filler body (35) has a guide structure (40) that rises up opposite the guide surface (36). The reinforcing fibres (32) are guided past the guide structure (36) through the inside of the rotor hub (20). The invention also relates to a method for producing a rotor and a turbomachine.

### BACKGROUND

The invention relates to a rotor which is particularly suitable for use in a turbomachine. The invention relates to a method for producing a rotor and a turbomachine.

Turbomachines are often operated at high speeds of several 10,000 revolutions per minute. At such high speeds, considerable mechanical forces act within the rotor. It is advantageous for the operation of the turbomachine if the rotor retains its geometric shape as far as possible despite the forces acting on it.

It is known that a rotor can be produced as a fiber-reinforced composite component. Reinforcing fibers can be embedded in a plastic matrix in the composite component. Reinforcing fibers are primarily capable of withstanding tensile loads. In the composite component, reinforcing fibers should therefore be guided in such a way that they are aligned along the tensile forces that occur during operation of the turbomachine.

When producing a composite component, the reinforcing fibers are usually first positioned and then a plastic material is added in a liquid state. The plastic material hardens and forms the plastic matrix in which the reinforcing fibers are embedded.

It can happen that the reinforcing fibers shift when the liquid plastic material is added and then no longer have the desired position and alignment within the rotor hub. Such a displacement of reinforcing fibers can have a detrimental effect on the quality of the rotor and, in particular, result in the forces acting during operation of the turbomachine being absorbed more poorly.

### SUMMARY

The invention addresses the problem of presenting a rotor, a method for producing a rotor and a turbomachine with which these problems can be avoided. The problem is solved with the features of the independent claims. Advantageous embodiments are given in the dependent claims.

A rotor according to the invention comprises a rotor hub and a plurality of rotor blades attached to the rotor hub. The rotor comprises a plurality of reinforcing fibers extending from a first rotor blade through the interior of the rotor hub to a second rotor blade. A first filler body is arranged inside the rotor hub. The first filler body has a guide surface with which a guide for the reinforcing fibers acting in the axial direction of the rotor is provided. The first filler body has a guide structure that rises up opposite the guide surface. The reinforcing fibers are guided past the guide structure through the inside of the rotor hub.

According to the invention, the guide structure of the filler body limits the areas within the rotor hub that are available for the path of the reinforcing fibers. The guide structure can be designed in such a way that the reinforcing fibers guided along the guide structure take a path through the interior of the hub, along which the reinforcing fibers are effectively integrated into the force flow within the rotor.

The rotor can be designed in such a way that each rotor blade is connected to at least one other rotor blade via a plurality of reinforcing fibers. Between the two rotor blades, between which a reinforcing fiber or a strand of reinforcing fibers extends, at least one further rotor blade, preferably at least three further rotor blades, more preferably at least five further rotor blades can be arranged. If the reinforcing fibers are not routed to an adjacent rotor blade but to an opposite or almost opposite rotor blade, deflections of the reinforcing fibers with a tight radius within the rotor hub can be avoided. For the transmission of tensile forces, it is advantageous if the radius with which the reinforcing fibers are deflected within the rotor hub is as large as possible. The rotor can be designed in such a way that the reinforcing fibers extend from one rotor blade to exactly one other rotor blade of the rotor. Alternatively, the rotor can also be designed in such a way that a first strand of reinforcing fibers extends from a first rotor blade to a second rotor blade and that a second strand of reinforcing fibers extends from the first rotor blade to a third rotor blade.

A first reinforcing fiber layer can be formed by a plurality of reinforcing fibers. The first reinforcing fiber layer can extend in a radial plane, i.e. a plane that is aligned perpendicular to the axial direction. The axial direction is parallel to the axis of rotation of the rotor. The rotor may comprise a plurality of reinforcing fiber layers, in particular at least three, preferably at least four, more preferably at least five reinforcing fiber layers. The reinforcing fiber layers can be arranged one behind the other in the axial direction of the rotor. In other words, the reinforcing fiber layers can be arranged in different axial portions of the rotor hub. Between every two adjacent reinforcing fiber layers, a spacer area can be formed that is free of reinforcing fibers. The spacer area corresponds to an axial portion of the rotor hub that is arranged between the axial portions of the reinforcing fiber layers. Within a reinforcing fiber layer, the reinforcing fibers can cross and/or overlap with each other.

The guide surface of the first filler body can be arranged between a first reinforcing fiber layer and a second reinforcing fiber layer, in particular between two adjacent reinforcing fiber layers. The guide surface can be arranged in a spacer area that is free of reinforcing fibers. The first filler body can extend in a radial plane over the cross-section of the rotor hub, so that the first reinforcing fiber layer and the second reinforcing fiber layer are completely separated from each other by the first filler body.

The guide structure of the filler body can rise from the guide surface in the axial direction. The guide structure can be arranged in the same axial portion of the rotor as a reinforcing fiber layer. The guide structure may cover the reinforcing fiber layer, in other words, an entire reinforcing fiber layer may be disposed within an axial portion of the rotor that is occupied by the guide structure. Accordingly, there is an axial portion of the rotor hub in which both the reinforcing fiber layer and the guide structure are arranged, with the reinforcing fiber layer extending in the areas left free by the guide structure. The guide structure defines those areas of the rotor hub that are not available for the path of the reinforcing fibers. The guide structure ensures that the reinforcing fibers cannot be displaced into the area of the guide structure even when the plastic material is added to the plastic matrix.

The guide structure can be designed in such a way that deflection of the reinforcing fibers with a tight radius is avoided during the transition of the reinforcing fibers from the rotor blade to the rotor hub. For this purpose, the guide structure can comprise a first structural component which is arranged between two adjacent rotor blades and which is preferably arranged adjacent to a lateral surface of the rotor hub. The guide structure can comprise a plurality of first structural components, so that a first structural component is arranged between each pair of adjacent rotor blades.

It is generally not possible to guide a reinforcing fiber in an exactly straight line from a first rotor blade to an opposite second rotor blade because a shaft holder is arranged in the center of the rotor hub, past which the reinforcing fibers must be guided. The required curvature of the path of the reinforcing fibers is preferably designed with the largest possible radius. The guide structure can comprise a second structural component that blocks a straight path from the blade root of a rotor blade in the direction of the axis of the rotor. The path of reinforcing fibers guided past the second structural component is suitably curved so that the reinforcing fibers can be guided to another rotor blade without colliding with the shaft mount. The second structural component can be arranged at a distance from the outside of the shaft mount and at a distance from the lateral surface of the rotor hub. Reinforcing fibers can extend both between the second structural component and the shaft mount and between the second structural component and the lateral surface of the rotor hub.

In the transition area between a rotor blade and the outer surface of the rotor hub, the outside of the rotor blade can be designed as a curved transition surface. A curved transition surface can prevent an abrupt kink at the transition between the essentially radially extending rotor blade and the circumferentially aligned lateral surface of the rotor hub. Such a curved transition surface creates additional space inside the rotor into which the reinforcing fibers can escape when the plastic material is added. To prevent this, the guide structure can have a third structural component that fills this space. The third structural component can protrude in a radial direction beyond the lateral surface of the rotor hub and extend into the area of the blade root of a rotor blade. The guide structure can have two such third structural components for a single rotor blade, so that a reinforcing fiber emerging from the rotor blade is arranged between the two third structural components. This can apply to each of the rotor blades of the rotor. The third structural component can be spatially separated from the other structural components of the guide structure. In one embodiment, the third structural component is integrally connected to the first structural component.

The filler body can have a rear side opposite the guide surface. The rear side can be designed as a closed surface that extends in a radial plane over the entire cross-section of the rotor hub. The rear side can be spaced from the guide surface in the axial direction. The distance between two reinforcing fiber layers adjacent to the filler body is preferably at least as large as the distance between the guide surface and the back of the filler body. The filler body can have an all-round sealed surface so that liquid plastic material cannot enter the interior of the filler body. A large volume of the filler body leads to a reduction in the weight of the rotor because the hollow filler body has a lower density than the plastic material. When determining the axial dimension of the filler body, a compromise must be found between the weight and the mechanical stability of the rotor.

The filler body can be a component produced using 3D printing. A reinforcing structure can be formed inside the guide structure to mechanically stabilize the outer surfaces of the guide structure. The reinforcing structure can, for example, take up between 5 % and 30 % of the inner volume of the guide structure. Apart from the reinforcing structure, the filler body can be hollow on the inside.

The rotor may comprise a plurality of such fillers, in particular two fillers, preferably three fillers, more preferably five fillers. Each filler body can have one or more of the features mentioned in connection with the first filler body. The fillers can be arranged one behind the other in the axial direction, so that each filler body is arranged in a different axial portion of the rotor hub. The rotor can be designed in such a way that a reinforcing fiber layer is assigned to each filler body. In other words, there is a reinforcing fiber layer for each filler body, which is arranged in the same axial portion of the rotor hub as the guide structure of the filler body.

The guide structure of the filler body can be open at the end opposite the guide surface so that the reinforcing fibers can be inserted into the free spaces remaining within the guide structure. After inserting the reinforcing fibers, the guide structure can be provided with a cover so that closed channels for the reinforcing fibers are formed between the guide surface, the guide structure and the cover. The cover can be formed by an adjacent filler body. In one embodiment, the rear side of the guide surface of a second filler body forms the cover for the guide structure of the first filler body.

Each rotor blade comprises a leading edge and a trailing edge, each extending from the blade root to a peripheral end of the rotor blade. The leading edge and trailing edge are connected to each other via a suction-side surface and a pressure-side surface, between which the body of the rotor blade is enclosed. It is advantageous for the mechanical properties of the rotor if the rotor blades are reinforced by reinforcing fibers in the area of the leading edge and in the area of the trailing edge. The rotor can be designed in such a way that the guide structure of a first filler body is arranged in the same axial plane as the leading edge of the blade root of a rotor blade and that the guide structure of a second filler body is arranged in the same axial plane as the trailing edge of the blade root of the rotor blade. One of the two fillers can have a guide surface in an axial plane that lies between the leading edge and the trailing edge. The other filler body can have a guide surface in an axial plane that is not between the leading edge and the trailing edge.

The rotor can comprise a shaft connection component that is aligned concentrically with the axis of rotation of the rotor. The shaft connection component can be designed to establish a mechanical connection to a shaft of a turbomachine. Three-dimensional structures can be formed on the outside of the shaft connection component, which can form an intimate connection with the plastic matrix of the composite component. In this way, the shaft connection component can be mechanically integrated into the structure of the rotor hub.

The surface of the rotor can be formed by a cover layer into which reinforcing fibers are embedded. The reinforcing fibers of the cover layer can intersect at regular intervals and form a checkered pattern, for example. The reinforcing fibers of the cover layer can form an angle of between 30° and 60° with the longitudinal direction of a rotor blade, for example. The cover layer can cover the surface of the rotor blades and/or the surface of the rotor hub. The surface of the rotor hub includes the areas of the outer surface of the rotor hub arranged between the rotor blades as well as a front end face and a rear end face. The front end face can be a closed surface. The rear end face can be interrupted by the receptacle for the shaft. The surface of the rotor can be completely or partially covered with the cover layer. The reinforcing fibers or strands of reinforcing fibers that extend from one rotor blade through the rotor hub to another rotor blade can be adjacent to the cover layer in the area of the rotor blades.

A turbomachine within the meaning of the invention is a machine with which a flow of a fluid, in particular an air flow, is driven by rotation of a rotor. The rotor has rotor blades which are shaped in such a way that the flow resulting from the rotation creates a pressure difference between the front and the rear of the rotor blades. Examples of turbomachines are propeller machines, in which the rotor blades move in free space, and impeller machines, in which the rotor blades are arranged inside an impeller housing.

A turbomachine according to the invention comprises a motor and a rotor designed according to the invention. The rotor is connected to a shaft driven by a motor. The motor is used to drive a flow of fluid in which the rotor rotates.

The invention further relates to an impeller machine with an impeller housing, a motor housing, a motor arranged in the motor housing and an annular space enclosed between the impeller housing and the motor housing. The rotor according to the invention is connected to a shaft driven by the motor, so that the rotor can be used to generate an air flow along the annular space. An impeller machine within the meaning of the invention is an axial flow machine. The air flow driven by the rotor has a flow direction that is parallel to the axis of the rotor. The rotor blades of the rotor, which are arranged in relation to the axis in the same radial section as the annular space arranged between the impeller housing and the motor housing.

The invention also relates to a method for producing a rotor having a rotor hub and a plurality of rotor blades attached to the rotor hub. In the method, a first filler body is introduced into a mold component, the mold component being designed to define a mold cavity corresponding to the shape of the rotor. The first filler body has a guide surface with which a guide acting in the axial direction of the rotor is provided, and a guide structure which rises opposite the guide surface. A plurality of reinforcing fibers are inserted into the guide structure of the first filler body so that each reinforcing fiber extends from a first rotor blade through the guide structure to a second rotor blade.

In the process, a first mold component and a second mold component can be used, which are separated from each other in a first state and which are connected to each other in a second state. In the connected state, the mold components enclose the mold cavity. The mold formed from the two mold components may comprise a plurality of inserts to enable separation of the mold components even if the rotor has undercuts. In one embodiment, an insert piece is assigned to each rotor blade.

At the start of the production process, the mold components can be separated from each other. The surfaces of the mold components that correspond to the later surface of the rotor can be covered with the top layer. A first filler body can be inserted into the area of a mold component that corresponds to the interior of the rotor hub so that the back of the filler body faces the mold component and the guide structure is accessible. Reinforcing fibers or strands of reinforcing fibers can be inserted into the mold component so that the reinforcing fibers or strands of reinforcing fibers adhere to the cover layer in the area of the rotor blades and are guided along the guide structure in the area of the rotor hub. The reinforcing fibers inserted into the guide structure of the first filler body can form a first reinforcing fiber layer. A second filler body can be inserted into the mold component so that the rear side of the second filler body covers the guide structure of the first filler body and that the first reinforcing fiber layer is enclosed between the guide surface of the first filler body, the guide structure of the first filler body and the rear side of the second filler body. A second reinforcing fiber layer can be inserted into the guide structure of the second filler body. This structure can be continued with further fillers, for example a third filler, a fourth filler and/or a fifth filler. A shaft connection component can also be inserted into the first mold component and the second mold component. The first mold component and the second mold component can be assembled so that the mold cavity corresponding to the shape of the rotor is formed. A plastic material introduced into the mold cavity in a liquid state can harden and form the plastic matrix of a composite component. The composite component has the shape of the rotor. The liquid plastic material can be introduced into the mold cavity before or after the first mold component and the second mold component are assembled. The disclosure includes further embodiments of the method according to the invention with one or more of the features mentioned in this paragraph.

The disclosure comprises further embodiments of the method with features described in connection with the rotor according to the invention. The disclosure comprises further embodiments of the rotor described in connection with the method according to the invention.

### BRIEF DESCRIPTION OF THE DRAWINGS

The invention is described below with reference to the accompanying drawings by way of example of advantageous embodiments, in which:

FIG. 1: shows an embodiment of a turbomachine according to the invention;

FIG. 2: shows a perspective view of a rotor according to the invention;

FIG. 3: shows a section in the axial direction through the rotor from FIG. 2;

FIG. 4: shows a section in a first radial plane through the rotor from FIG. 2;

FIG. 5: shows a section in a second radial plane through the rotor from FIG. 2;

FIG. 6: shows a plurality of filler body elements arranged one behind the other;

FIG. 7: shows a sectional view of a tower filler body.

### DETAILED DESCRIPTION

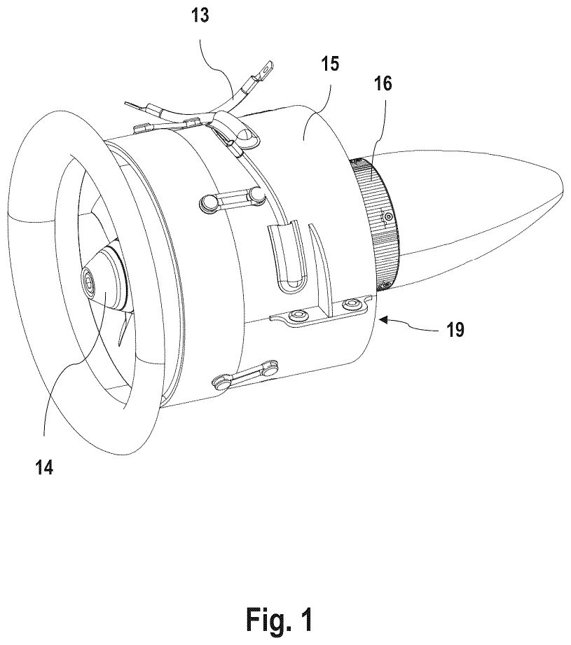

According to FIG. 1, a turbomachine according to the invention in the form of an impeller machine comprises a rotor 14, which is arranged in an impeller housing 15. Motor housing 16 is held in an interior of the impeller housing 15, in the interior of which an electric motor is arranged. The electric motor drives a shaft so that the rotor 14 connected to the shaft rotates about an axis 17, see FIG. 3. The motor is supplied with energy via electrical connections 13. A direction perpendicular to the axis 17 is referred to as the radial direction, and a plane perpendicular to the axial direction 17 is referred to as the radial plane 18.

In an annular space 19, which is enclosed radially outside the motor housing 16 and radially inside the impeller housing 15, a plurality of struts is formed, with which the motor housing 16 is held in position relative to the impeller housing 15. The rotor 14 comprises a plurality of rotor blades 21, which rotate around a front end of the annular space 19. The rotation of the rotor 14 generates an air flow which extends from the rotor 14 through the annular space 19 to the opposite, rear end of the impeller machine.

An impeller machine within the meaning of the invention is an axial-flow machine with a high degree of efficiency, which has a running number σ between 1.8 and 10 and a diameter number δ between 0.8 and 1.5 in the Cordier diagram. The impeller machine according to the invention differs from radial flow machines with high efficiency by a higher value for the number of revolutions σ and a lower value for the number of diameters δ. The impeller machine according to the invention differs from sheathless propeller machines in that it has a lower value for the number of revolutions σ and a higher value for the number of diameters δ.

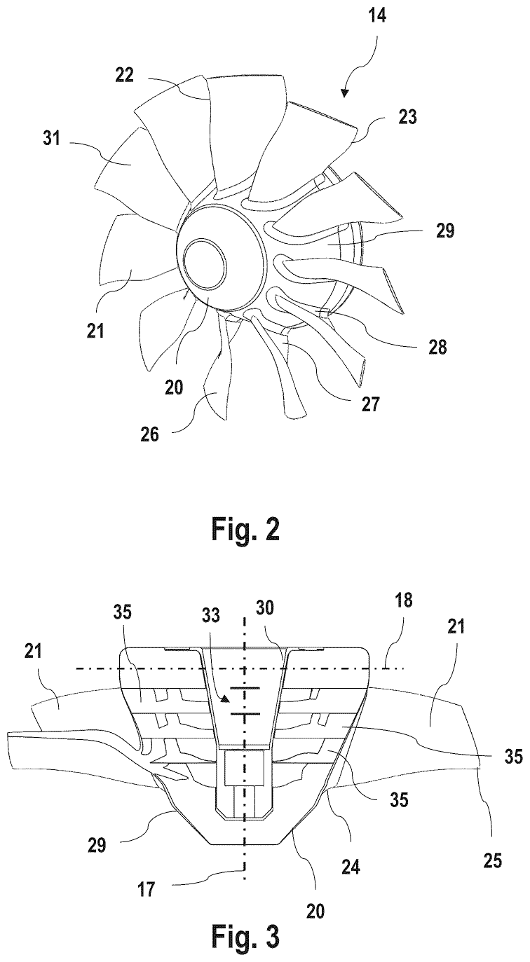

According to FIGS. 2, 3, a rotor 14 according to the invention comprises a rotor hub 20 with a lateral surface 29 to which a plurality of rotor blades 21 is attached. Each rotor blade 21 extends from a blade root 24 adjacent to the rotor hub 20 to a peripheral end 25. During operation of the impeller machine, the peripheral end 25 of the rotor blade 21 has a very small distance from the inner wall of the impeller housing 15. Each rotor blade 21 has a leading edge 22, which is hit by the incoming air flow during operation of the impeller machine, and an end edge 23 opposite the leading edge 22. A suction-side outer surface 26 and a pressure-side outer surface 27 extend between the leading edge 22 and the trailing edge 23. The transition between the blade root 24 and the outer surface 29 of the rotor hub 20 is formed by a rounded transition surface 28.

Inside the rotor hub 20 and coaxial to the axis 17 of the rotor 14, a shaft connection component 30 made of aluminum is arranged, via which the rotor 14 is connected to the shaft of the impeller machine. The shaft connection component 30 forms part of the surface of the rotor. The remaining part of the rotor surface is formed by a cover layer 31 of a composite material.

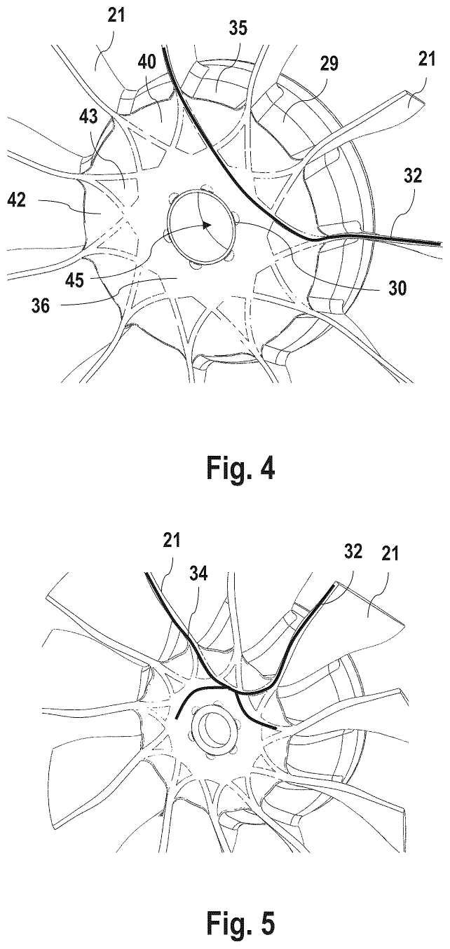

A plurality of reinforcing fibers are arranged inside the rotor 14, extending from a first rotor blade 21 to a second rotor blade 21. In FIG. 4, a single strand of composite fibers 32 is shown, which is an example of a plurality of strands of reinforcing fibers 32 arranged in this axial portion 33 of the rotor 14. Together, the reinforcing fibers 32 of this axial portion 33 form a reinforcing fiber layer 34. A reinforcing fiber layer 34 is indicated in FIG. 5 by means of the reinforcing fibers 32 arranged in another axial portion 33 of the rotor 14.

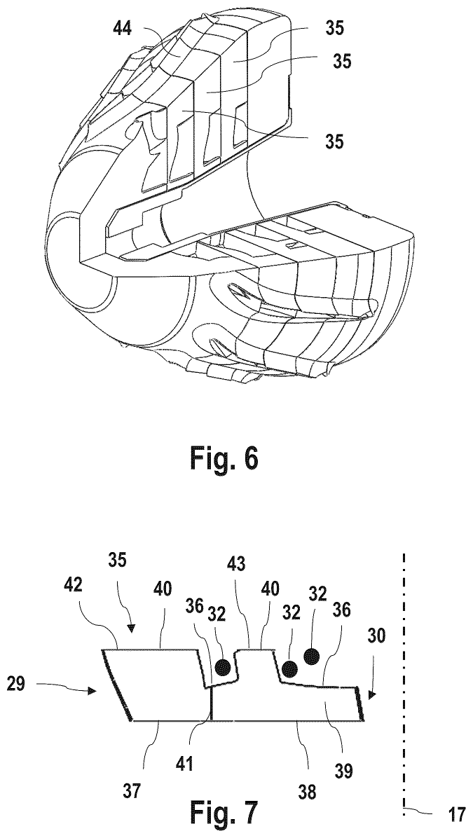

The interior of the rotor hub 20 comprises a plurality of fillers 35, which are arranged one behind the other in the axial direction 17 of the rotor 14, see FIG. 3. A stack of fillers 35 created in this way is shown in FIG. 6. FIG. 7 shows a section of a filler body 35 arranged between the lateral surface 29 of the rotor hub 20 and the shaft connection component 30 in a sectional view. The filler body 35 has a guide surface 36, which provides a guide for the reinforcing fibers 32 in the axial direction 17. The filler body 35 also has a guide structure 40 which rises up opposite the guide surface 36. The guide structure 40 defines sections within a radial plane 18 that are not available for the reinforcing fibers 32. The reinforcing fibers 32 extend in the free spaces that remain within the guide structure 40. The free spaces are configured such that the reinforcing fibers 32 can be inserted into the free spaces without being deflected at a tight radius.

The filler body 35 is enclosed by a closed outer wall 38. The interior 39 of the filler body 35 is essentially hollow so that the filler body 35 has the lowest possible weight. Only a reinforcing structure 41 is formed in the interior of the filler body 35, which is shown schematically in FIG. 7. The reinforcing structure 41 takes up between 10% and 20% of the volume in the interior of the filler body 35; the rest of the filler body 35 is hollow. The surface opposite the guide surface 36 is referred to as the rear side 37 of the filler body 35. The rear side 37 is at a distance from the guide surface 36, so that the filler body 35 has a high volume and a low density. This helps to keep the weight of the rotor 14 low.

As shown in FIG. 4, the guide structure 40 of the tower filler body 35 comprises a plurality of first structural components 42 and a plurality of second structural components 43. The first structural components 42 are each arranged between two rotor blades 21 and ensure that the reinforcing fibers 32 are not deflected with a narrow radius in the area of the blade root 24. The second structural components 43 are arranged in extension of the rotor blades 21 and ensure that the reinforcing fibers 32 are guided past the shaft connection component 30. In addition, the fillers 35 comprise third structural components 44, which project beyond the lateral surface of the rotor hub into the area of the blade root 24 of a rotor blade 21. In the present embodiment example, the third structural components 44 are integrally connected to the first structural components 42.

For the production of such a rotor, two mold components are provided which are designed to enclose a cavity corresponding to the shape of the rotor 14 between them when they are assembled. To enable demolding, the mold components may be provided with the required number of inserts. In a state in which the mold components are separated from each other, the areas of the mold components corresponding to the surface of the rotor 14 are covered with a cover layer 31. A first filler body 35 is inserted into one of the mold components so that the rear side 37 of the filler body faces the mold component and that the guide structure 40 of the filler body 35 is accessible. Strands of reinforcing fibers 32 are inserted into the mold component so that the reinforcing fibers 32 extend from a first rotor blade 21 via the free spaces of the guide structure 40 to a second rotor blade 21. This is carried out with a sufficient number of reinforcing fibers 32 so that a first reinforcing fiber layer 34 is formed, which is arranged in an axial portion of the rotor 33. A second filler body 35 is placed with its rear side 37 on the first filler body 35 so that the first reinforcing fiber layer 34 is enclosed all around. This is continued with further fillers 35 and reinforcing fiber layers 34 until a plurality of reinforcing fiber layers 34 are formed inside the hub 20, which are arranged in parallel axial portions of the hub 20.

The mold components 35 enclose a central opening 45 into which the shaft connection component 30 is inserted. The two mold components are assembled. A plastic material, which is introduced into the cavity in a liquid state, hardens and forms the plastic matrix of the composite component.

1. A rotor, in particular for a turbomachine, comprising a rotor hub (20) and a plurality of rotor blades (21) attached to the rotor hub (20), with a plurality of reinforcing fibers (32), wherein each reinforcing fiber (32) extends from a first rotor blade (21) through the interior of the rotor hub (20) to a second rotor blade (21), wherein a first filler body (35) is arranged inside the rotor hub (20), wherein the first filler body (35) has a guide surface (36) with which a guide for the reinforcing fibers (32) acting in the axial direction of the rotor is provided, wherein the first filler body (35) has a guide structure (40) that rises up opposite the guide surface (36), and wherein the reinforcing fibers (32) are guided past the guide structure (36) through the inside of the rotor hub (20).

2. The rotor as claimed in claim 1, wherein a first reinforcing fiber layer (34) is formed by a plurality of reinforcing fibers (32), which is arranged in a radial plane (18) of the rotor hub (20).

3. The rotor as claimed in claim 2, wherein the guide structure (40) of the first filler body (35) is arranged in the same axial portion (33) of the rotor hub (20) as the first reinforcing fiber layer (34).

4. The rotor of claim 2, with a first reinforcing fiber layer (34) and a second reinforcing fiber layer (34), wherein the guide surface (36) of the first filler body (35) is arranged between the first reinforcing fiber layer (34) and the second reinforcing fiber layer (34).

5. The rotor of claim 1, wherein the guide structure (40) comprises a first structural component (42) arranged adjacent to a lateral surface (29) of the rotor hub (20) and between two adjacent rotor blades (21).

6. The rotor of claim 1, wherein the guide structure (40) comprises a second structural component (43) blocking a rectilinear path between the blade root (24) of a rotor blade (21) and the axis (17) of the rotor.

7. The rotor of claim 1, wherein the guide structure (40) comprises a third structural component (44) which projects beyond the lateral surface (29) of the rotor hub (20) and extends into the region of the blade root (24) of a rotor blade (21).

8. The rotor of claim 1, wherein the first filler body (35) has a cavity arranged between the guide surface (36) and a rear side (37) of the first filler body (35) spaced apart from the guide surface (36) in the axial direction.

9. The rotor as claimed in claim 8, wherein the first filler body (35) has an all-round sealed surface.

10. The rotor of claim 1, with a first filler body (35) and a second filler body, wherein the guide structure (40) of the first filler body (35) is covered by the second filler body.

11. A turbomachine with a motor and with a rotor (14), wherein the rotor (14) is connected to a shaft driven by the motor, and wherein the rotor (14) is designed according to claim 1.

12. A method for producing a rotor with a rotor hub (20) and a plurality of rotor blades (21) attached to the rotor hub (20), in which a first filler body (35) is introduced into a mold component, wherein the mold component defines a mold cavity corresponding to the shape of the rotor, wherein the first filler body (35) has a guide surface (36) with which a guide acting in the axial direction of the rotor is provided, and wherein the first filler body (35) has a guide structure (40) which rises opposite the guide surface (36), and in which a plurality of reinforcing fibers (32) are inserted into the guide structure (40) of the first filler body so that each reinforcing fiber (32) extends from a first rotor blade (21) through the guide structure (40) to a second rotor blade (21).
